(19) United States
(12) Patent Application Publication
(10) Pub. No.: US 2014/0152638 A1
(43) Pub. Date: Jun. 5, 2014

(54) ELECTROPHORETIC DISPLAY MODULE AND CONTROL METHOD THEREOF

(71) Applicants: Chih-Yuan Kuo, New Taipei City (TW); Tzu-An Lin, Hsinchu City (TW)

(72) Inventors: Chih-Yuan Kuo, New Taipei City (TW); Tzu-An Lin, Hsinchu City (TW)

(21) Appl. No.: 13/786,386

(22) Filed: Mar. 5, 2013

(30) Foreign Application Priority Data
Dec. 5, 2012 (TW) 101145688

(51) Int. Cl. G09G 3/34

(52) U.S. Cl. CPC G09G 3/344
USPC 345/212; 345/107

(57) ABSTRACT

An electrophoretic display module includes an electrophoretic display panel, a driving circuit, and a power converter. The electrophoretic display panel includes a plurality of display units. Each of the display units is configured to display images according to a display voltage. The driving circuit is electrically connected to the plurality of display units for outputting the display voltage to the corresponding display unit according to a first driving voltage and a second driving voltage, and changing the display voltage according to a display signal. The power converter is configured to output the first driving voltage and the second driving voltage to the driving circuit according to a power source during a frame refreshing period, wherein the power converter is turned off after a predetermined length of time following the driving circuit changing the display voltage.

### BACKGROUND OF THE INVENTION

1. Field of the Invention

The present invention relates to an electrophoretic display module, and more particularly, to an electrophoretic display module capable of reducing power consumption.

2. Description of the Prior Art

Please refer to FIG. 1. FIG. 1 is a diagram showing an electrophoretic display module of the prior art. As shown in FIG. 1, the electrophoretic display module 100 of the prior art comprises an electrophoretic display panel 110, a driving circuit 120, and a power converter 130. The electrophoretic display panel 110 comprises a plurality of display units D1-Dn. Each of the display units D1-Dn is configured to display images according to a corresponding display voltage Vd1-Vdn respectively. The driving circuit 120 is electrically connected to the plurality of display units D1-Dn for outputting the display voltage Vd1-Vdn to the corresponding display unit D1-Dn according to a first driving voltage V1 and a second driving voltage V2, and changing the display voltage Vd1-Vdn according to a display signal S1-Sn. The power converter 130 is configured to output the first driving voltage V1 and the second driving voltage V2 to the driving circuit 120 according to a power source.

Please refer to FIG. 2, and refer to FIG. 1 as well. FIG. 2 is a diagram showing waveforms of related signals when the electrophoretic display module in FIG. 2 refreshing a frame. As shown in FIG. 2, during a frame refreshing period T, when the electrophoretic display module 100 starts to refresh a frame at time t0, an enable signal Ve is pulled up to a high voltage level, and the power converter 130 is continuously turned on for outputting the first driving voltage V1 and the second driving voltage V2 to the driving circuit 120. The driving circuit 120 then changes the display voltages Vd1-Vdn outputting to the corresponding display units D1-Dn according to the display signals S1-Sn respectively. For example, when the display signal Sk of the display unit Dk is changed from a state 00b to a state 01b at time t1, the driving circuit 120 pulls up the display voltage Vdk corresponding to the display unit Dk from 0 to +V according to the display signal Sk; when the display signal Sk of the display unit Dk is changed from the state 01b to the state 00b at time t2, the driving circuit 120 pulls down the display voltage Vdk corresponding to the display unit Dk from +V to 0 according to the display signal Sk; when the display signal Sk of the display unit Dk is changed from the state 00b to a state 10b at time t3, the driving circuit 120 further pulls down the display voltage Vdk corresponding to the display unit Dk from 0 to −V according to the display signal Sk; when the display signal Sk of the display unit Dk is changed from the state 10b to the state 00b at time t4, the driving circuit 120 pulls up the display voltage Vdk corresponding to the display unit Dk from −V to 0 according to the display signal Sk; and finally, when the electrophoretic display module 100 finishes refreshing the frame at time t5, the enable signal Ve is pulled down to a low voltage level, and the power converter 130 is turned off accordingly. In addition, the first driving voltage V1 and the second driving voltage V2 have voltage drops when the display voltages Vd1-Vdn are changed. And each time when the display voltages Vd1-Vdn are changed by the driving circuit 120, since each of the display voltages Vd1-Vdn is changed in different way, both of the first driving voltage V1 and the second driving voltage V2 have voltage drops at the time point when the display voltages Vd1-Vdn are changed.

According to the above arrangement, the display unit D1-Dn can refresh display images according to the display voltages Vd1-Vdn. However, in the prior art, when the electrophoretic display module 100 refreshes a frame, the power converter 130 is continuously turned on, so as to increase power consumption of the electrophoretic display module 100. Therefore, the electrophoretic display module 100 of the prior art has bad power management efficiency.

### SUMMARY OF THE INVENTION

The present invention provides an electrophoretic display module comprising an electrophoretic display panel, a driving circuit, and a power converter. The electrophoretic display panel comprises a plurality of display units. Each of the display units is configured to display images according to a display voltage. The driving circuit is electrically connected to the plurality of display units for outputting the display voltage to the corresponding display unit according to a first driving voltage and a second driving voltage, and changing the display voltage according to a display signal. The power converter is configured to output the first driving voltage and the second driving voltage to the driving circuit according to a power source during a frame refreshing period, wherein the power converter is turned off after a predetermined length of time following the driving circuit changing the display voltage.

The present invention further provides a control method of an electrophoretic display module. The control method comprises providing an electrophoretic display panel having a plurality of display units, each of the display units being configured to display images according to a display voltage; a power converter outputting a first driving voltage and a second driving voltage to a driving circuit during a frame refreshing period; the driving circuit outputting the display voltage to the corresponding display unit according to the first driving voltage and the second driving voltage; the driving circuit changing the display voltage according to a display signal; and during the frame refreshing period, turning off the power converter after a predetermined length of time following the driving circuit changing the display voltage.

In contrast to the prior art, the electrophoretic display module of the present invention is capable of turning off the power converter according to a time point when the display voltage is changed during the frame refreshing period, such that power consumption of the electrophoretic display module can be reduced. Therefore, the electrophoretic display module of the present invention has better power management efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an electrophoretic display module of the prior art.

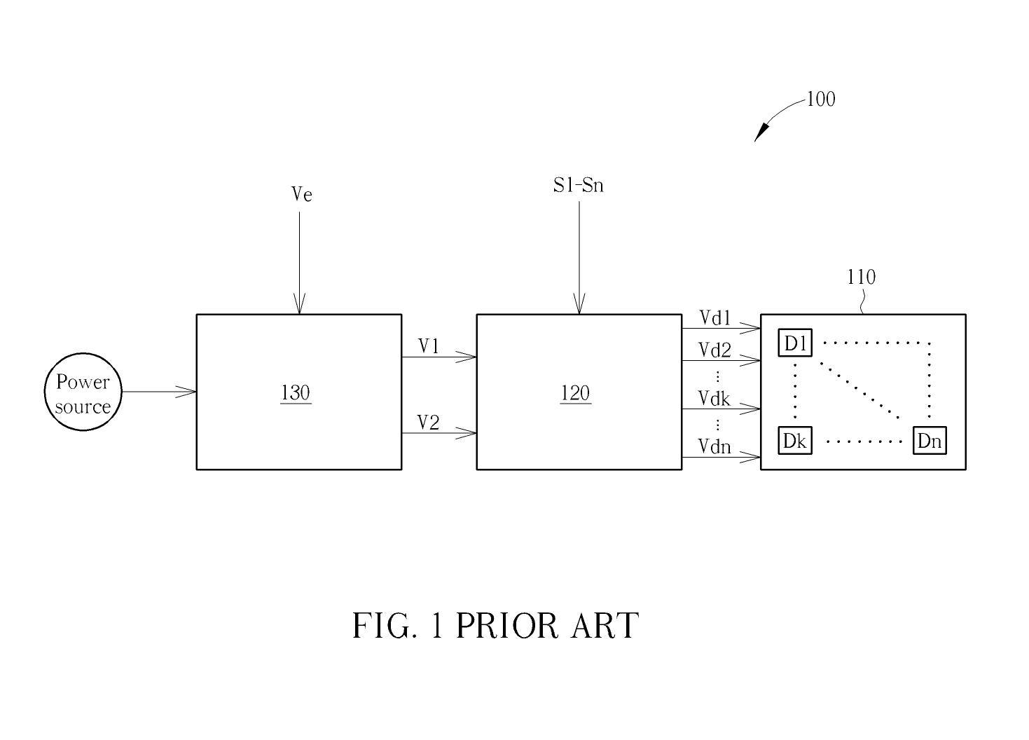

FIG. 2 is a diagram showing waveforms of related signals when the electrophoretic display module in FIG. 2 refreshing a frame.

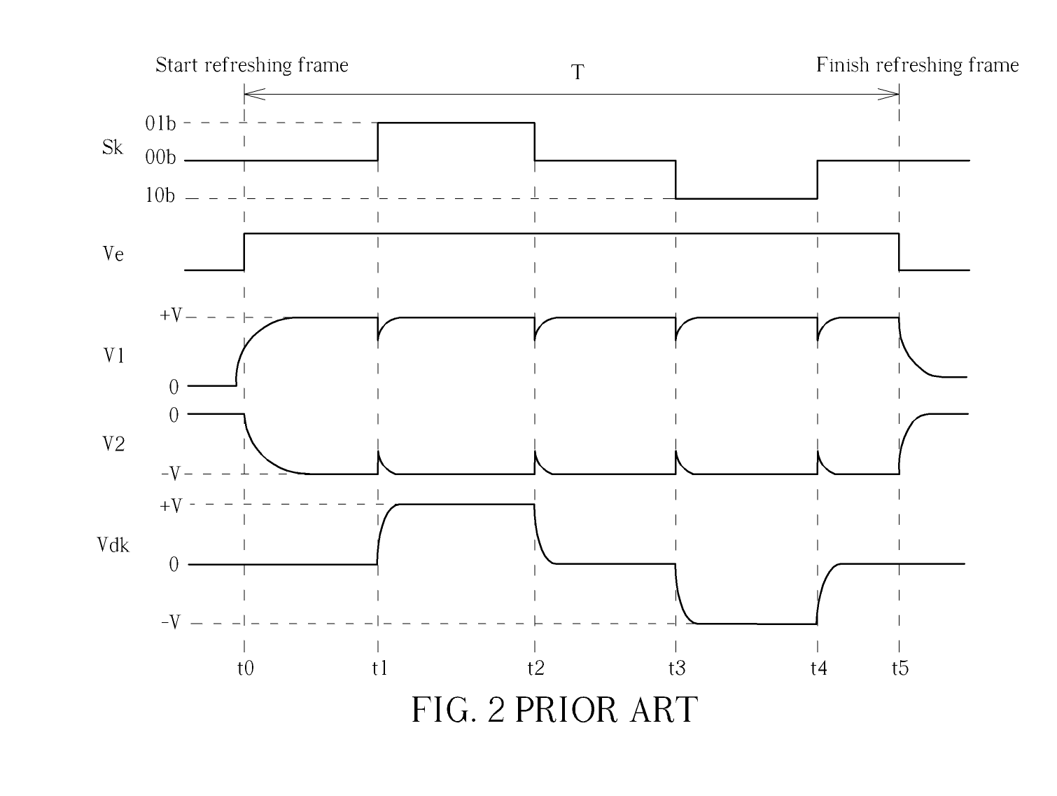

FIG. 3 is a diagram showing an electrophoretic display module of the present invention.

FIG. 4 is a diagram showing waveforms of related signals when the electrophoretic display module in FIG. 3 refreshing a frame.

FIG. 5 is a flowchart showing the control method of the electrophoretic display module of the present invention.

### DETAILED DESCRIPTION

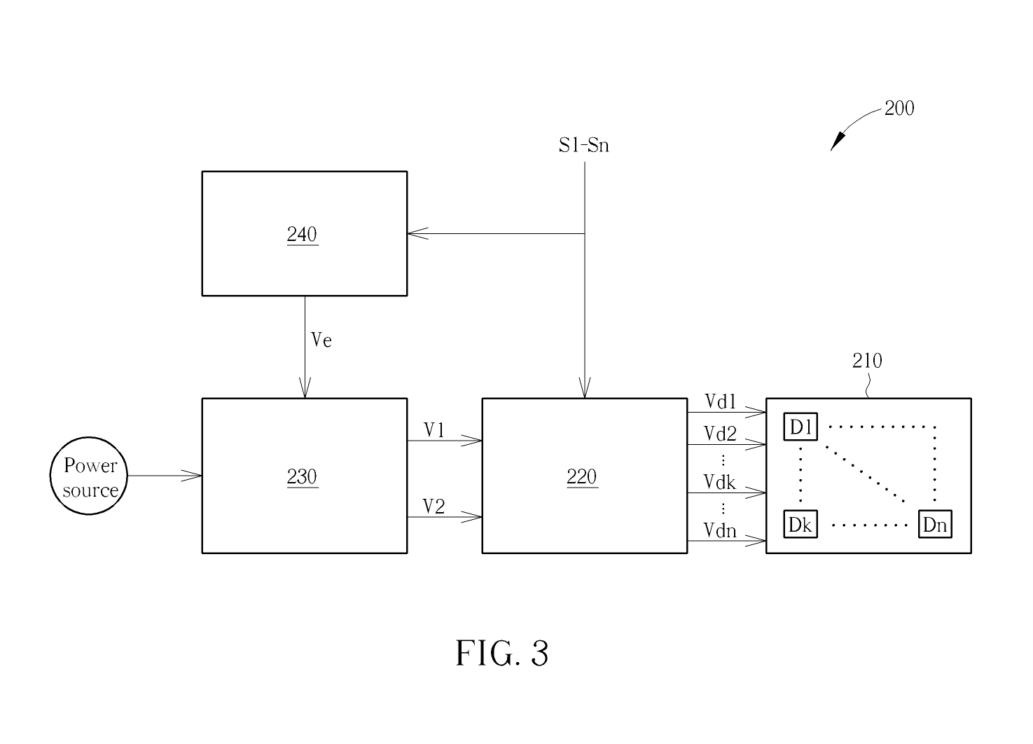

Please refer to FIG. 3. FIG. 3 is a diagram showing an electrophoretic display module of the present invention. As shown in FIG. 3, the electrophoretic display module 200 of the present invention comprises an electrophoretic display panel 210, a driving circuit 220, and a power converter 230. The electrophoretic display panel 210 comprises a plurality of display units D1-Dn. Each of the display units D1-Dn is configured to display images according to a corresponding display voltage Vd1-Vdn respectively. The driving circuit 220 is electrically connected to the plurality of display units D1-Dn for outputting the display voltage Vd1-Vdn to the corresponding display unit D1-Dn according to a first driving voltage V1 (such as a positive voltage) and a second driving voltage V2 (such as a negative voltage), and changing the display voltage Vd1-Vdn according to a display signal S1-Sn. The power converter 230 is configured to output the first driving voltage V1 and the second driving voltage V2 to the driving circuit 220 according to a power source (such as a battery). The electrophoretic display module 200 of the present invention further comprises a control circuit 240 configured to output an enable signal Ve to the power converter 230 according to the display signal S1-Sn for controlling on and off states of the power converter 230.

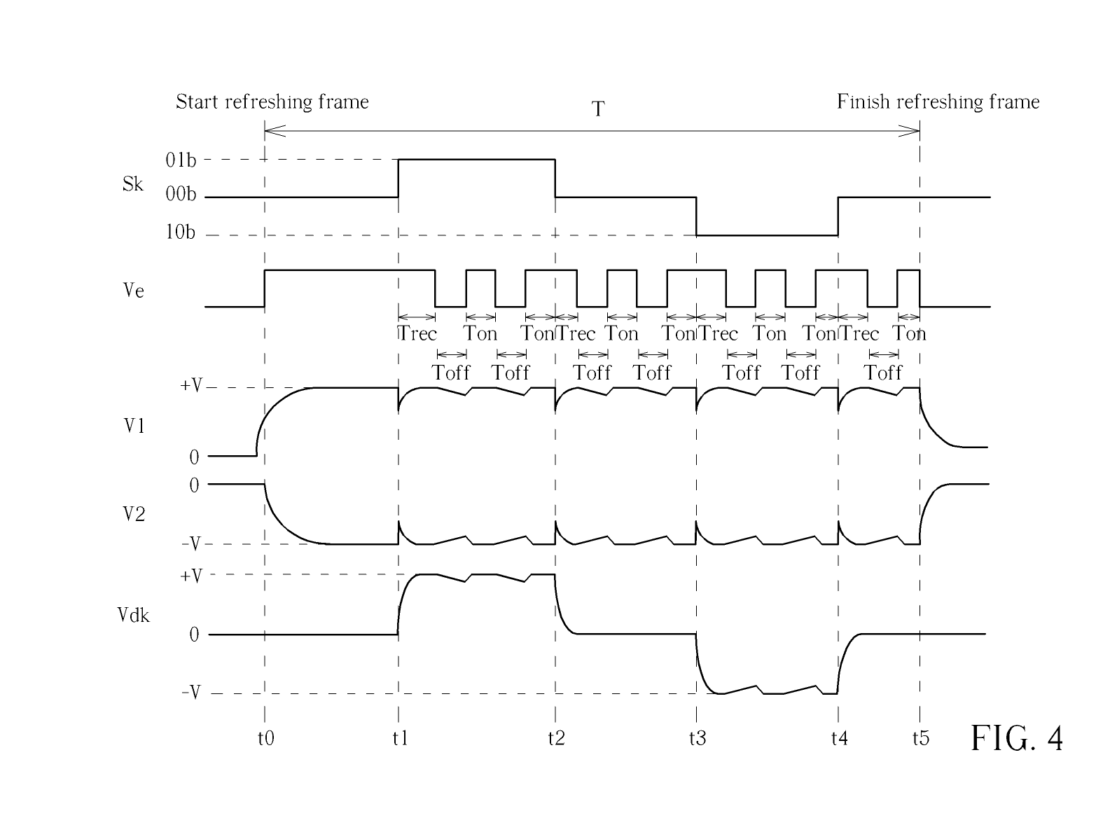

Please refer to FIG. 4, and refer to FIG. 3 as well. FIG. 4 is a diagram showing waveforms of related signals when the electrophoretic display module in FIG. 3 refreshing a frame. In order to reduce power consumption of the electrophoretic display module 200, during a frame refreshing period, the control circuit 240 can control on and off states of the power converter 230 according to time points when states of the display signal are changed (that is the time points when the display voltages are changed). For example, as shown in FIG. 4, during a frame refreshing period T, when the electrophoretic display module 200 starts to refresh a frame at time t0, the control circuit 240 pulls up the enable signal Ve to a high voltage level, for turning on the power converter 230, such that the power converter 230 outputs the first driving voltage V1 and the second driving voltage V2 to the driving circuit 220. The driving circuit 220 then changes the display voltages Vd1-Vdn outputting to the corresponding display units D1-Dn according to the display signals S1-Sn respectively. When the display signal Sk of the display unit Dk is changed from a state 00b to a state 01b at time t1, the driving circuit 220 pulls up the display voltage Vdk corresponding to the display unit Dk from 0 to +V according to the display signal Sk, and the first driving voltage V1 and the second driving voltage V2 have voltage drops due to changes of the display voltages Vd1-Vdn. The control circuit 240 continuously turns on the power converter 230 for a recovery time Trec (a predetermined length of time) after time t1, so as to recover the first driving voltage V1 and the second driving voltage V2 to original voltage levels. After the recovery time Trec, the control circuit 240 pulls down the enable signal Ve to a low voltage level, for turning off the power converter 230. Since the power converter 230 generally comprises capacitors and/or inductors at an output end, after the power converter 230 is turned off, the output end of the power converter 230 still can keep outputting the first driving voltage V1 and the second driving voltage V2 to the driving circuit 220, but absolute values of voltage levels of the first driving voltage V1 and the second driving voltage V2 are decreased as time goes by, and the display voltages Vd1-Vdn are also changed along with the first driving voltage V1 and the second driving voltage V2. In order to avoid affecting display images displayed by the display units D1-Dn, the control circuit 240 interlacedly turns off and turns on the power converter 230 for keeping the display voltages Vd1-Vd1 within a proper range.

When the display signal Sk of the display unit Dk is changed from the state 01b to the state 00b at time t2, the driving circuit 220 pulls down the display voltage Vdk corresponding to the display unit Dk from +V to 0 according to the display signal Sk. Similarly, the control circuit 240 continuously turns on the power converter 230 for the recovery time Trec after time t2, so as to recover the first driving voltage V1 and the second driving voltage V2 to the original voltage levels. And after the recovery time Trec, the control circuit 240 turns off the power converter 230. In addition, the control circuit 240 also interlacedly turns off and turns on the power converter 230 for keeping the display voltages Vd1-Vd1 within the proper range.

When the display signal Sk of the display unit Dk is changed from the state 00b to a state 10b at time t3, the driving circuit 220 further pulls down the display voltage Vdk corresponding to the display unit Dk from 0 to −V according to the display signal Sk. Similarly, the control circuit 240 continuously turns on the power converter 230 for the recovery time Trec after time t3, so as to recover the first driving voltage V1 and the second driving voltage V2 to the original voltage levels. And after the recovery time Trec, the control circuit 240 turns off the power converter 230. In addition, the control circuit 240 also interlacedly turns off and turns on the power converter 230 for keeping the display voltages Vd1-Vd1 within the proper range.

When the display signal Sk of the display unit Dk is changed from the state 10b to the state 00b at time t4, the driving circuit 220 pulls up the display voltage Vdk corresponding to the display unit Dk from −V to 0 according to the display signal Sk. Similarly, the control circuit 240 continuously turns on the power converter 230 for the recovery time Trec after time t4, so as to recover the first driving voltage V1 and the second driving voltage V2 to the original voltage levels. And after the recovery time Trec, the control circuit 240 turns off the power converter 230. In addition, the control circuit 240 also interlacedly turns off and turns on the power converter 230 for keeping the display voltages Vd1-Vd1 within the proper range.

Finally, when the electrophoretic display module 200 finishes refreshing the frame at time t5, the control circuit 240 pulls down the enable signal Ve to the low voltage level, for turning off the power converter 230.

According to the above arrangement, during the frame refreshing period, the power converter 230 is not continuously turned on, but is turned off after a recovery time Trec following changing of the display voltages Vd1-Vdn. Therefore, the power consumption of the electrophoretic display module 200 can be reduced.

On the other hand, if a time interval between the two adjacent time points when the display voltages are changed is not very long, changes of the display voltages may not affect the images displayed by the display units, thus the control circuit 240 can continuously turnoff the power converter 230 after the recovery time Trec following changing of the display voltages Vd1-Vdn instead of interlacedly turning off and turning on the power converter 230.

In addition, the power converter 230 can be a DC-to-DC power converter. During the frame refreshing period, the control circuit 240 can turn on the power converter 230 when the driving circuit 220 changes the display voltages, or the control circuit 240 can turn on the power converter 230 before the driving circuit 220 changes the display voltages.

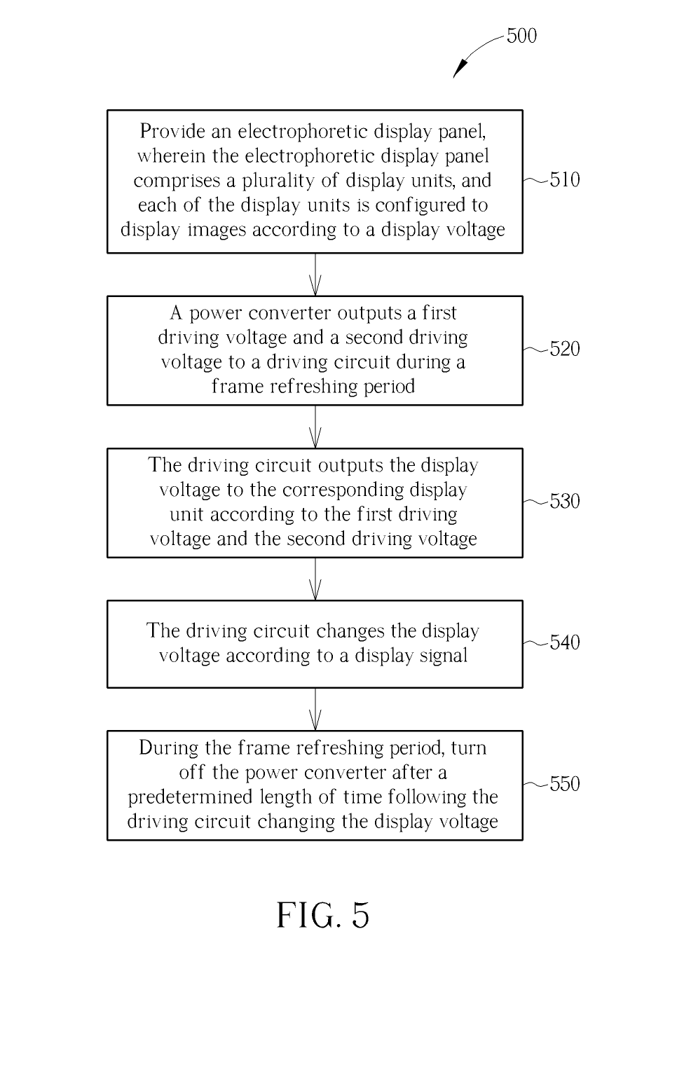

Please refer to FIG. 5. FIG. 5 is a flowchart 500 showing the control method of the electrophoretic display module of the present invention. The flowchart of control method of the electrophoretic display module of the present invention comprises the following steps:

Step 510: Provide an electrophoretic display panel, wherein the electrophoretic display panel comprises a plurality of display units, and each of the display units is configured to display images according to a display voltage;

Step 520: A power converter outputs a first driving voltage and a second driving voltage to a driving circuit during a frame refreshing period;

Step 530: The driving circuit outputs the display voltage to the corresponding display unit according to the first driving voltage and the second driving voltage;

Step 540: The driving circuit changes the display voltage according to a display signal; and

Step 550: During the frame refreshing period, turn off the power converter after a predetermined length of time following the driving circuit changing the display voltage.

In contrast to the prior art, the electrophoretic display module of the present invention is capable of turning off the power converter according to a time point when the display voltage is changed during the frame refreshing period, such that power consumption of the electrophoretic display module can be reduced. Therefore, the electrophoretic display module of the present invention has better power management efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrophoretic display module, comprising:
an electrophoretic display panel having a plurality of display units, each of the display units being configured to display images according to a display voltage;
a driving circuit electrically connected to the plurality of display units for outputting the display voltage to the corresponding display unit according to a first driving voltage and a second driving voltage, and changing the display voltage according to a display signal; and
a power converter configured to output the first driving voltage and the second driving voltage to the driving circuit according to a power source during a frame refreshing period, wherein the power converter is turned off after a predetermined length of time following the driving circuit changing the display voltage.

2. The electrophoretic display module of claim 1, wherein the first driving voltage is a positive voltage, and the second driving voltage is a negative voltage.

3. The electrophoretic display module of claim 1, wherein the power converter is a DC-to-DC power converter.

4. The electrophoretic display module of claim 1 further comprising a control circuit configured to output an enable signal to the power converter according to the display signal for controlling on and off states of the power converter.

5. The electrophoretic display module of claim 1, wherein the power converter is interlacedly turned off and turned on after the predetermined length of time following the driving circuit changing the display voltage.

6. A control method of an electrophoretic display module, comprising:
providing an electrophoretic display panel having a plurality of display units, each of the display units being configured to display images according to a display voltage;
a power converter outputting a first driving voltage and a second driving voltage to a driving circuit during a frame refreshing period;
the driving circuit outputting the display voltage to the corresponding display unit according to the first driving voltage and the second driving voltage;
the driving circuit changing the display voltage according to a display signal; and
during the frame refreshing period, turning off the power converter after a predetermined length of time following the driving circuit changing the display voltage.

7. The control method of claim 6 further comprising turning on the power converter when the driving circuit changing the display voltage.

8. The control method of claim 6 further comprising turning on the power converter before the driving circuit changing the display voltage.

9. The control method of claim 6, wherein the first driving voltage is a positive voltage, and the second driving voltage is a negative voltage.

10. The control method of claim 6 further comprising outputting an enable signal to the power converter for controlling on and off states of the power converter.

11. The control method of claim 6, wherein turning off the power converter after the predetermined length of time following the driving circuit changing the display voltage is interlacedly turning off and turning on the power converter after the predetermined length of time following the driving circuit changing the display voltage.
